(19) United States
(12) Patent Application Publication
(10) Pub. No.: US 2023/0259199 A1
(43) Pub. Date: Aug. 17, 2023

(54) SELECTION OF REAL-WORLD OBJECTS USING A WEARABLE DEVICE

(71) Applicant: Google LLC, Mountain View, CA (US)

(72) Inventors: Mark Chang, Seattle, WA (US); Xavier Benavides Palos, San Francisco, CA (US); Alexandr Virodov, Orangevale, CA (US); Adarsh Prakash Murthy Kowdle, San Francisco, CA (US); Kan Huang, Mountain View, CA (US)

(21) Appl. No.: 17/651,209

(22) Filed: Feb. 15, 2022

(51) Int. Cl. G06F 3/01; G02B 27/00; G02B 27/01; G06T 19/00

(52) U.S. Cl. CPC G06F 3/013; G02B 27/0093; G02B 27/0179; G02B 27/0101; G02B 27/017; G06T 19/006; G02B 2027/0138; G02B 2027/0178; G02B 2027/0187

(57) ABSTRACT

A method including receiving an image from a sensor of a wearable device, rendering the image on a display of the wearable device, identifying a set of targets in the image, tracking a gaze direction associated with a user of the wearable device, rendering, on the displayed image, a gaze line based on the tracked gaze direction, identifying a subset of targets based on the set of targets in a region of the image based on the gaze line, triggering an action, and in response to the trigger, estimating a candidate target based on the subset of targets.

### FIELD

Embodiments relate to object and/or object attribute (e.g., text) selection using a wearable device.

### BACKGROUND

Augmented reality (AR) devices (e.g., a wearable device) can be used to perform many operations to enhance a user experience. One of those operations can be to, for example, translate text. In order to perform some of these operations, the AR device selects a virtual and/or real-world object and/or object attribute (e.g., text) through a user interaction as input for the operation. The inability to select the virtual and/or real-world object and/or object attribute accurately can adversely affect the user experience.

### SUMMARY

In a general aspect, a device, a system, a non-transitory computer-readable medium (having stored thereon computer executable program code which can be executed on a computer system), and/or a method can perform a process with a method including receiving an image from a sensor of a wearable device, rendering the image on a display of the wearable device, identifying a set of targets in the image, tracking a gaze direction associated with a user of the wearable device, rendering, on the displayed image, a gaze line based on the tracked gaze direction, identifying a subset of targets based on the set of targets in a region of the image based on the gaze line, triggering an action, and in response to the trigger, estimating a candidate target based on the subset of targets.

In another general aspect, a wearable device including an image sensor, a display, at least one processor, and at least one memory including computer program code, the at least one memory and the computer program code configured to, with the at least one processor, cause the wearable device to receive an image from the image sensor, render the image on the display, identify a set of targets in the image, track a gaze direction associated with a user of the wearable device, render, on the displayed image, a gaze line based on the tracked gaze direction, identify a subset of targets based on the set of targets in a region of the image based on the gaze line, trigger an action, and in response to the trigger, estimate a candidate target based on the subset of targets.

Implementations can include one or more of the following features. For example, the method (and/or computer program code) can further include identifying the subset of targets based on a region encompassing the gaze line and estimating a depth associated with each target in the set of targets, wherein the estimating of the candidate target based on an intersection of the gaze line at a depth included in the region. The method (and/or computer program code) can further include detecting a change in gaze direction, determining that the change is less than a threshold and re-rendering the image on a display of the wearable device. The method (and/or computer program code) can further include detecting a change in gaze direction, determining that the change is less than a threshold, and re-rendering the gaze line. The method (and/or computer program code) can further include detecting a change in gaze direction, determining that the change is within the rendered image and closer to the subset of targets, and re-rendering the gaze line with a change in color. The method (and/or computer program code) can further include detecting a change in gaze direction, determining that the change is greater than a threshold, and receiving another image from the sensor. The method (and/or computer program code) can further include rendering a reticle on the displayed image based on a position of the candidate target. The method can further include causing the reticle to relocate to a different position on the displayed image, wherein candidate target is estimated based on the relocated reticle. The method (and/or computer program code) can further include calibrating the wearable device based on a position of the sensor of the wearable device and a center of a display of the wearable device.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1A illustrates a side perspective view of a user gazing at a plurality of objects in a real-world scene according to an example implementation.

FIG. 1B illustrates a front perspective view of the user gazing at the plurality of objects in the real-world scene according to an example implementation.

FIG. 2 illustrates a three-dimensional rendering of an image space according to an example implementation.

FIG. 3 illustrates a three-dimensional rendering of an image space according to an example implementation.

FIG. 4 illustrates a block diagram of a calibration data flow according to an example implementation.

FIG. 5 illustrates a block diagram of a gaze tracking with target identification data flow according to an example implementation.

FIG. 6 illustrates a block diagram of a method of target identification according to an example implementation.

FIG. 7 illustrates a block diagram of a system according to an example implementation.

FIG. 8 shows an example of a computer device and a mobile computer device according to at least one example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

A user wearing a wearable device (e.g., smart glasses) may desire to perform an action (e.g., translate a specific text) based on a target (e.g., a street sign) or portion of a target (e.g., line on a multiline street sign) in the user's environment. However, there may be more than one candidate target (multiple street signs) or portion of the candidate target (e.g., multiline street sign) to perform the action (e.g., translate) on.

The disclosed solution enables the user to communicate to the wearable device (e.g., smart glasses) which target or portion of the target the user intends to perform the action on. For example, the solution can provide a function that a user of the wearable device uses to communicate a selection of a real-world target, object, and/or region of interest in the real world to the wearable device.

The technical solution can include identifying a set of targets in an image captured using an image sensor of the wearable device. A gaze of a user of the wearable device can then be used to determine a subset of targets based on the gaze direction. Then a candidate target(s) can be estimated and/or selected from the subset of targets should the action be triggered. Various techniques can be used to reduce the set of targets to the subset of targets and/or estimate the candidate target(s). For example, a gaze line, a reticle and/or some other visual tool can be used to focus or help focus the gaze of the user to limit the possible targets the user intents to perform the action on.

The benefit of this solution is to improve the user experience by minimizing frustration due to receipt of, for example, incorrect information. A technical benefit can be to reduce the use of limited resources (processing, power, and/or the like) in the wearable device resulting from re-performing actions due to obtaining an in accurate or incorrect response from the action.

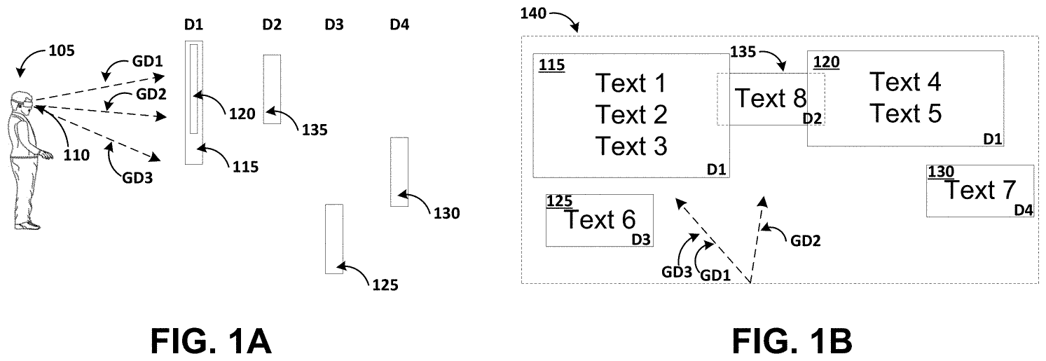

A user wearing a wearable device can view many targets (or objects) in a real-world scene. Determining, by the wearable device, which target and what on the target the user is interested in can be difficult. FIGS. 1A and 1B can be used to describe (and/or refer to) example implementations for determining which of the many targets is a candidate target. FIGS. 1A and 1B show how the implementations described herein can address the difficulty in discerning which of the many targets is a candidate target (or target of interest).

FIG. 1A illustrates a side perspective view of a user gazing at a plurality of targets in a real-world scene according to an example implementation. FIG. 1A shows a user 105 wearing a wearable device 110 (e.g., AR/VR device) looking at a scene (e.g., a real-world scene including a plurality of targets 115, 120, 125, 130, 135. The plurality of targets 115, 120, 125, 130, 135 are at depths D1, D2, D3, D4 (e.g., a distance away from the wearable device 110). FIG. 1B illustrates a front perspective view of the user gazing at the plurality of targets in the real-world scene according to an example implementation. As shown in FIG. 1B, the real-world scene 140 includes the plurality of targets 115, 120, 125, 130, 135. The plurality of targets 115, 120, 125, 130, 135 have associated text text1, text2, text3, text4, text5, text6, text7. FIGS. 1A and 1B show a gaze direction GD1, GD2, GD3 as a direction (up-down, side-to-side) of view of the user 105 looking at the real-world scene 140.

Referring to FIG. 1A target 115 and target 120 are at depth D1, target 135 is at depth D2, target 125 is at depth D3, and target 130 is at depth D4. Referring to FIG. 1B target 115 and target 125 are to the left, target 120 and target 130 are to the right, and target 135 is in-between and overlapping target 115 and target 120 (noting that target 135 is behind target 115 and target 120 as indicated by the dashed lines).

Referring to FIG. 1A, GD1 is generally in the upward direction toward target 120 and target 115. Referring to FIG. 1B, GD1 is generally in the left direction toward target 115 and target 125. Based on the direction of GD1, the most likely region of the image representing the real-world scene 140 can be (or include) target 115. However, target 115 includes text1, text2, and text3. Therefore, target 115 may be in the region of the image representing the real-world scene 140 and a subset of targets can be identified as text1, text2, and text3. In an example implementation, a candidate target can be estimated based on the subset of targets or estimated as one of text1, text2, and text3. Techniques described below can used to reduce the subset of targets and/or estimate the candidate target. In other words, the techniques described below can used to select or estimate one of text1, text2, and text3 as the candidate target (e.g., the target of interest to the user 105 of the wearable device 110).

Referring to FIG. 1A, GD2 is generally in the straight ahead to slightly downward direction toward target 115, 120, 130 and target 135. Referring to FIG. 1B, GD2 is generally in the straight ahead to slightly right direction toward target 120 and target 135. Based on the direction of GD2, the most likely region of the image representing the real-world scene 140 can be (or include) target 120 and target 135. However, target 120 includes text4 and texts. Therefore, target 120 and target 135 may be in the region of the image representing the real-world scene 140 and a subset of targets can be identified as text4, text5, and text8 (text8 being in target 135). In an example implementation, a candidate target can be estimated based on the subset of targets or estimated as one of text4, text5, and text8. Techniques described below can used to reduce the subset of targets and/or estimate the candidate target. In other words, the techniques described below can used to select or estimate one of text4, text5, and text8 as the candidate target (e.g., the target of interest to the user 105 of the wearable device 110). One of the techniques to estimate the candidate target can be based on depth because target 120 is at depth D1 and target 135 is at depth D2.

Referring to FIG. 1A, GD3 is generally in the downward direction toward target 130 and target 135. Referring to FIG. 1B, GD3 is generally in the left direction toward target 115 and target 125. Based on the direction of GD3, the most likely region of the image representing the real-world scene 140 can be (or include) target 125. Therefore, target 125 may be in the region of the image representing the real-world scene 140 and a subset of targets can be identified as text6. In an example implementation, a candidate target can be estimated based on the subset of targets or estimated as text6. Techniques described below can used to reduce the subset of targets and/or estimate the candidate target. The most likely result can be estimating or selecting text6 as the candidate target (e.g., the target of interest to the user 105 of the wearable device 110) because the subset of targets is a subset of one.

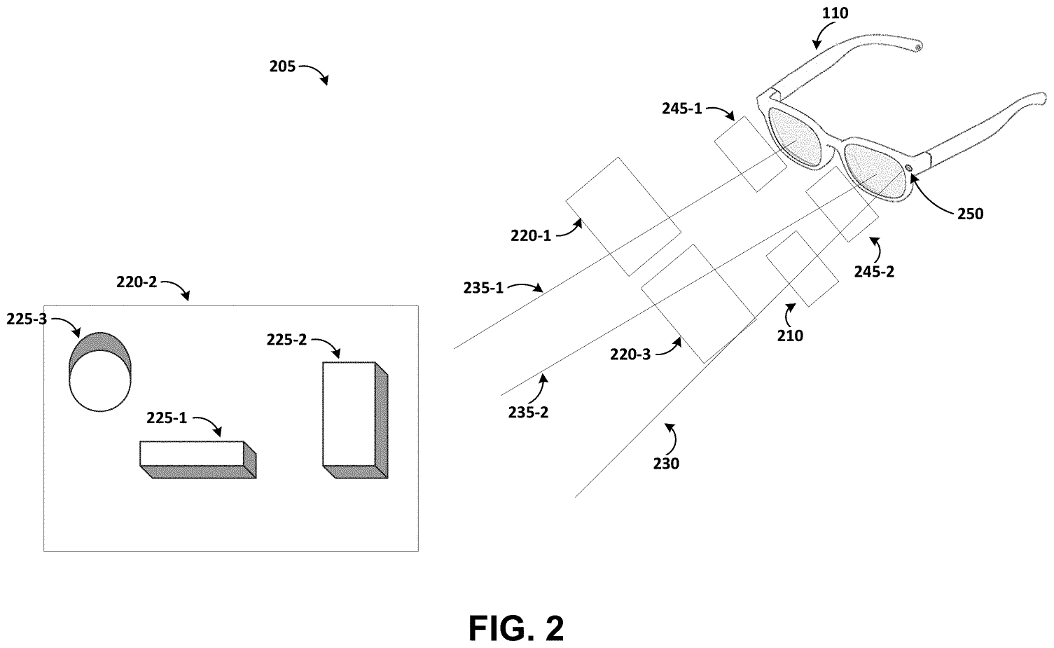

The aforementioned techniques can use details about an image space to determine useful information about gaze direction, camera centers and offsets, object depth, and user input (e.g., via a reticle, head movements, and the like). FIGS. 2-5 illustrate various image space details used to determine the useful information.

FIG. 2 illustrates a three-dimensional rendering of an image space according to an example implementation. The three-dimensional (3D) rendering can be based on a camera view frustrum and a lens or screen view frustrum. A view frustum is a truncated pyramid that determines what can be in view. Only objects within the frustum can appear on the screen and/or in an image. The camera (or the eye) is at the tip of the pyramid. The pyramid extends out in a direction that is away from the camera (or the eye). The frustum starts at the near plane and ends at the far plane. These planes are parallel and their normals are along the gaze direction or direction of the camera (e.g., a direction the eye or the camera is looking). The length of the frustum is determined by the distance from the camera (or eye) to the near plane and the distance from the camera to the far plane. In an example implementation, the division to far field/near field can stem from the observation that an epipolar line (e.g., a line from the eye to the image plane) of the user's gaze as seen from the camera is concentrated in a small region of image space. For an example wearable device use case far-field objects can be objects with a distance greater than one (1) meter.

As shown in FIG. 2, there can be a camera (e.g., camera 250) view frustrum 210, a lens (of the wearable device) view frustrum 245-1, 245-2, and a screen (displayed on the lens of the wearable device) view frustrum 220-1, 220-3. The camera view frustrum 210 can have an associated epipolar line 230 and the screen view frustrum 220-1, 220-3 can have an associated gaze line 235 (e.g., an epipolar line).

An image 220-2 in the real-world scene 205 can be located at image plane associated with the screen view frustrum 220-1, 220-3. The image 220-2 can include objects 225-1, 225-2, 225-3.

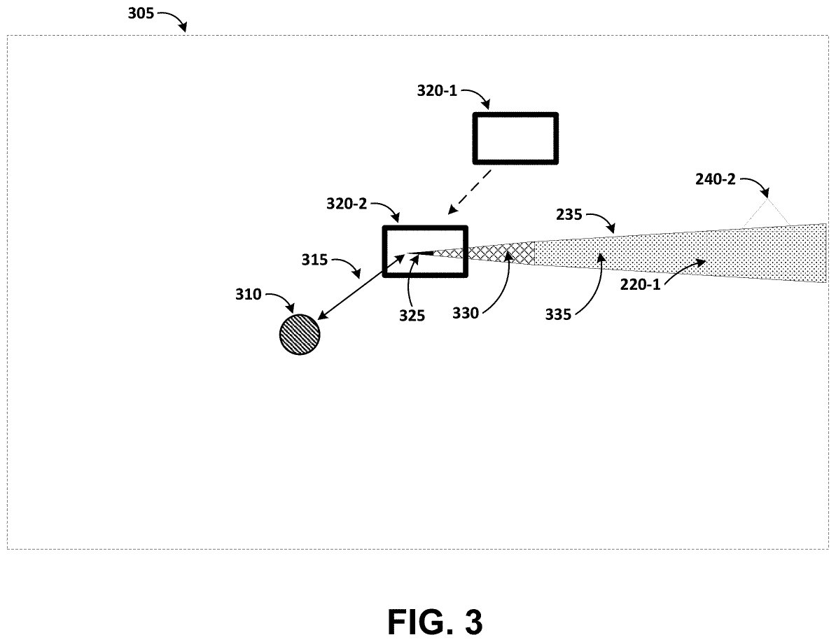

In an example implementation, the gaze line 235-1, 235-2 can be used to determine the gaze direction (e.g., GD1, GD2, GD3). In FIG. 2, the gaze line 235-1, 235-2 points to object 225-1. In addition, there is no indication that the gaze line 235-1, 235-2 points to any other object (e.g., objects 225-2 and 225-3). Therefore, in the example of FIG. 2, object 225-1 may be, or may include the candidate target (e.g., the target of interest to the user 105 of the wearable device 110). Should the object 225-1 include several targets (e.g., text), an example implementation can include use of a gaze line, a reticle and/or some other visual tool to help the user indicate the which of the several targets is the candidate target. FIG. 3 can be used to describe the use of a gaze line and a reticle.

FIG. 3 illustrates a three-dimensional rendering of an image space according to an example implementation. As shown in FIG. 3, a screen 305 (e.g., as a display on a lens, or a portion of the lens of a wearable device) shows the gaze line 235 (representing either of the gaze line 235-1, 235-2). The gaze line 235 can be dimensionally of a fixed size as displayed on the screen 305. The gaze line 235 can be disposed on (within, with, and the like) the rendered image with a first end at an edge of the rendered image and a second end near the center of the rendered image. The gaze line 235 can have a somewhat triangular or conical shape. The gaze line 235 can have a first end at or about an outside edge (e.g., a rightmost edge) of the rendered image. The first end of the gaze line 235 can be relatively longer than the second. The second end of the gaze line 235 can come to a point with a taper from the first end of the gaze line 235.

The gaze line 235 can be used to indicate a gaze direction and as a pointer to an object as a possible candidate target. The gaze line 235 can be displayed with many portions 325, 330, 335 of different colors. The portions 325, 330, 335 can be disposed along the longitudinal axis of the gaze line 235. The portions 325, 330, 335 each can have a length that is less than the whole length of the gaze line 235. The portions 325, 330, 335 can be tapered along the longitudinal axis of the gaze line 235. The first portion 325 can be disposed at the second edge of the gaze line 235 and include the point of the gaze line 235. The third portion 335 can be disposed at the second end of the gaze line 235 at the edge of the rendered image. The third portion 330 can be disposed along the longitudinal axis of the gaze line 235 between the first portion 325 and the third portion 335. The portions 325, 330, 335 of the different colors can be used to indicate proximity to an object. For example, there can be three colors. Color1 (associated with portion 325) can indicate the user 105 is close (e.g., within one (1) meter) to the object. Color2 (associated with portion 330) can indicate the user 105 is in a medium range (e.g., between one (1) and three (3) meters) to the object. Color3 (associated with portion 335) can indicate the user 105 is in a distant range (e.g., greater than three (3) meters) to the object.

The screen 305 can be a fixed size such that an object that is far away (e.g., far-field) can be relatively (e.g., as compared to the same object that is close by) small in size. Further, an object that is nearby (e.g., near-field) can be relatively (e.g., as compared to the same object that is far away) large in size. In addition, as the user 105 moves closer to the object (or the object moves closer to the user 105), the object can appear adaptively larger. In an example implementation, the dominant color of the gaze line 235 can be color3 (associated with portion 335) because the user 105 is relatively far away from the object. As the user 105 moves closer to the object, color3 can be less dominant and color1 (associated with portion 325) and color2 (associated with portion 330) become more prevalent until color2 is the dominant color, color1 is less dominant, and color3 is not shown (or can be a small band). Then, as the user 105 moves closer to the object color2 can progress to being less dominant until color2 disappears (or can be a small band) and color1 can become more dominant until color1 is substantially the only color of the gaze line 235.

The gaze line 235 can be used to identify a subset of targets based on a region encompassing the gaze line. A depth associated with each target in the set of targets can be estimated. The estimating of the candidate target can be based on an intersection of the gaze line at a depth included in the region and/or a target of the subset of targets. A change in gaze direction can be detected. For example, head movement and/or eye movement can be detected. If the change in gaze direction is less than a threshold the image can be re-rendered (e.g., to account for the minimal change in gaze direction) on a display of the wearable device. In addition, the gaze line can be redrawn. If the change in gaze direction is greater than or equal to the threshold another image can be received from the sensor and rendered on the display of the wearable device. The gaze line may or may not be redrawn.

As shown in FIG. 3, the screen 305 can include a reticle 320-1, 320-2. The reticle 320-1, 320-2 can be used to identify (e.g., with minimal ambiguity) a target. The reticle 320-1, 320-2 is illustrated as a rectangle. However, the reticle 320-1, 320-2 can be any shape (e.g., square, circle, oval, and/or the like). The user 105 can cause (e.g., with head and/or eye movement) the reticle 320-1, 320-2 to move on the screen 305 to more accurately (e.g., likelihood of being an incorrect target goes down) select (or help select) the candidate target. Alternatively (or additionally), the user 105 can cause the image to move with the reticle 320-1, 320-2 maintained in a position on the screen 305. For example, the reticle 320-1 is in a first position and the reticle 320-2 is in a second position. In an example implementation, the second position may be the preferred position for selecting a target and/or a candidate target. Therefore, the user 105 can cause (e.g., with head and/or eye movement) the position of reticle 320-1 to move to the position of reticle 320-2 on the screen 305.

Estimating a gaze can include processing the user's 105 gaze as in a fixed position with respect to the wearable device 110. For example, the gaze direction can be co-linear with the user's 105 head for a head worn wearable device 110. However, gaze direction can also be based on eye view direction as well as head direction. In an example implementation, the reticle 320 can force the eye view direction to be fixed (e.g., eyes focus on the position of the reticle 320). For example, the screen 305 can be a pass-through display such that the reticle 320 and the gaze line 235 drawn on the screen 305 can intersect can cause the eye gaze direction can be co-linear with the user's 105 head gaze direction when selecting an object as a candidate target.

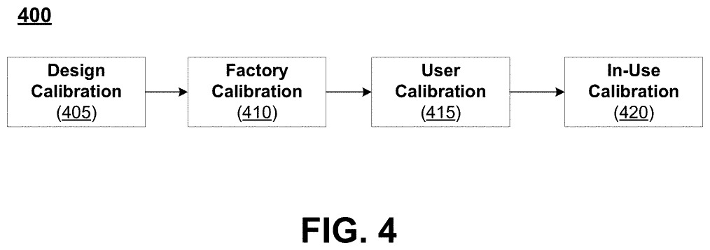

A calibration can be used to align (e.g., align a center of) the screen 305 and the camera 250. For example, circle 310 can represent the camera 250 center vector and the point of the gaze line 235 can represent the screen 305 center vector. An offset line 315 can represent a distance and direction of an offset between the camera 250 center vector and the screen 305 center vector. Accordingly, the calibration can cause an image received from the camera 250 to be displayed on the screen 305 to be shifted based on the offset (represented by the offset line 315). Alternatively, the calibration can cause the gaze line 235 and/or the reticle 320, as displayed on the screen 305, to be shifted based on the offset (represented by the offset line 315). The calibration can include, for example, a computer aided design (CAD) calibration, a factory calibration, an infield user calibration and/or an in-field automatic calibration. FIG. 4 illustrates a block diagram of a calibration data flow according to an example implementation.

A CAD calibration 405 can be determined during the CAD design of the wearable device 110. For example, the CAD calibration can be based on an orientation and positioning between the camera 250 and a predetermined user gaze (e.g., an average user's gaze) as the wearable device 110 is designed using, for example, a CAD software tool. A factory calibration 410 can be a process or operation that can cause the adjustment of the calibration (e.g., the CAD calibration) after a specific wearable device 110 is manufactured. The factory calibration can account for the actual positioning between camera 250 and the predetermined user gaze (e.g., an average user's gaze) is as determined for the specific wearable device 110.

An in-field user calibration 415 can be a process or operation by which the user 105 can further adjust the calibration by executing a sequence of prescribed steps. The in-field user calibration can be performed prior to first use by the user 105. For example, the user 105 can use an object easily recognizable by computer vision algorithms as, for example, a calibration marker. For example, the object can be printed on the product box, or the product box can be used as the object. The user 105 can place the object in the user's 105 environment in the far field (e.g., greater than 1 meter). The user 105 can initiate a calibration software while gazing at the object. An in-field user calibration 420 can be repeated multiple times for better accuracy. The in-field automatic calibration can be a process or operation by which the calibration is further adjusted during use. For example, a discrepancy between a detected object center and a gaze estimate can be used as corrective feedback to a calibration process or operation. After calibration, target identification with gaze tracking can be performed (in-field automatic calibration while performing target identification with gaze tracking).

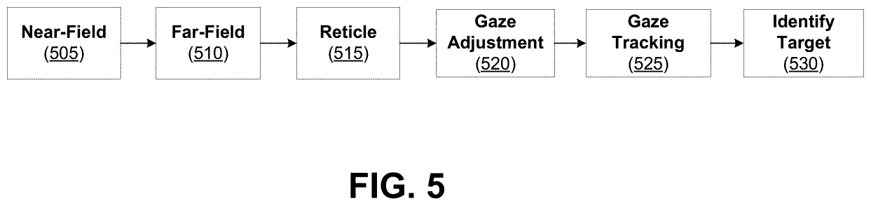

FIG. 5 illustrates a block diagram of a gaze tracking with target identification data flow according to an example implementation. As shown in FIG. 5, the data flow includes a near-field 505 block, a far-field 510 block, a reticle 515 block, a gaze adjustment 520 block, a gaze tracking 525 block, and an identify target 530 block.

The near-field 505 can be configured to estimate user gaze and/or gaze direction in the near-field (e.g., within one (1) meter of the wearable device). In the near-field the user's gaze can span a considerable portion of the image. Therefore, a large number of objects can be in the user's field-of-view. Some of the objects can be further away than what is considered as within the near-field. In other words, an object in the displayed image can be seen by the user even though the object is far away (e.g., greater than one (1) meter from the wearable device). For example, referring to FIGS. 1A and 1B, D1 can be 0.5 meters from the wearable device 110 and D3 can be five (5) meters from the wearable device 110. Therefore, target 115 and target 120 can be in the near-field and target 125 can be in the far-field. However, the user's gaze can span a considerable portion of the image (including objects as the targets) displayed on the screen 305. Therefore, target 115, target 120, and target 125 could appear as being in the user's gaze and possibly the near-field.

In an example implementation, the wearable device 110 can include a depth sensor (or include another method of determining depth). Therefore, the image displayed on the screen 305 can have an associated depth map (or other depth information). The depth map can be used to estimate the user's gaze and/or gaze direction and the subset of targets (e.g., objects) that are in the near-field. For example, the near-field can be predetermined as one meter or less (in relation to the wearable device 110). Accordingly, the depth map can be used to eliminate target 125 from the subset of targets.

The far-field 510 can be configured to estimate user gaze direction in the far-field (e.g., greater than one (1) meter from the wearable device). In the far-field the user's gaze can span a variable portion of the image. For example, as the user's gaze gets further from the wearable device, the user's gaze can span a smaller and smaller portion of the image. Therefore, the further away the user is gazing, the fewer number of objects can be in the user's field-of-view. Accordingly, estimating the user's gaze and/or gaze direction can be more accurate (as compared to estimating in the near-field). As mentioned above, the wearable device 110 can include depth sensors the image displayed on the screen 305 can have an associated depth map (or other depth information). Therefore, the gaze line 235 drawn on the screen 305 can use the depth map to increase accuracy of identifying targets. In addition, the depth (e.g., metric depth) along the gaze line can be determined using one of the aforementioned calibration techniques. Therefore, identifying targets that intersect the gaze line 235 can also include determining and/or estimating a depth of the identified targets.

The reticle 515 can be configured to force the eye view direction to be fixed (e.g., eyes focus on the position of the reticle). For example, the screen 305 can be a pass-through display such that the reticle 320 and the gaze line 235 drawn on the screen 305 can intersect can cause the eye gaze direction can be co-linear with the user's 105 head gaze direction when selecting an object as a candidate target. Gaze direction estimation can include determining that the user's gaze is fixed with respect to the wearable. For example, the gaze direction can be co-linear with the user's head for a head worn wearable device. However, humans tend to gaze with their eyes as well as their head. Therefore, the reticle 516 can be configured to force the gaze direction to be fixed.

The gaze adjustment 520 can be configured to fix the gaze direction based on correlations between the wearable device position, a device trajectory and the user gaze. For example, when a user looks at a sign (e.g., in an upward direction), the user's eyes can be monitored to estimate a gaze adjustment. A model that takes as input the wearable position in space to the extent known (3dof or 6dof) and past trajectory and produces a correction to the gaze estimate. The model can be a machine learned model (e.g., a trained neural network) or an algorithm used to calculate an offset (based on a current gaze direction). The reticle 515 and the gaze adjustment 520 can be used together and/or separately.

The gaze tracking 525 can be configured to track the user's rotational gaze (e.g., using head movement). For example, a source of rotational tracking (e.g., 3dof movement) can include the use of sensors associated with the wearable device. The sensors can include a movement sensor providing linear acceleration and rotational velocity (e.g., an inertial measurement unit (IMU)). Changes in wearable orientation can be translated to changes in gaze location in image space, allowing the user to continuously select among detected objects. Gaze tracking 525 can be performed without the capturing or rendering of a new image. The rotational tracking can also be used to re-trigger capture and detection if the user's current gaze ventures outside of the currently displayed image. Example implementations may not be sensitive to small translational movements, where small is relative to distance to object of interest. However, for large translational movements (e.g., movement above a threshold), the current set of detected targets (e.g., objects) can be discarded and the capturing and rendering of a new image together with identifying targets can be triggered. Depth information can also be used to reproject the objects as the wearable device moves without the capture of a new image.

The identify target 530 can be configured to identify potential targets. The gaze direction and/or gaze line can be used to identify a subset of targets based on a region encompassing the gaze line. A depth associated with each target in the set of targets can be estimated. The estimating of the candidate target can be based on an intersection of the gaze line at a depth included in the region and/or a target of the subset of targets. In an example implementation, an action can be triggered (e.g., translate text, find best price, read a map, get directions, identify an image, read a product label, identify a storefront, identify a restaurant, read a menu, identify a building, identify a product, identify nature items (e.g., plant, flower, tree, and the like) and/or the like) and in response to the trigger, a candidate target can be estimated (or selected) based on the subset of targets. For example, if the action is to translate text, the text can be associated with the candidate target.

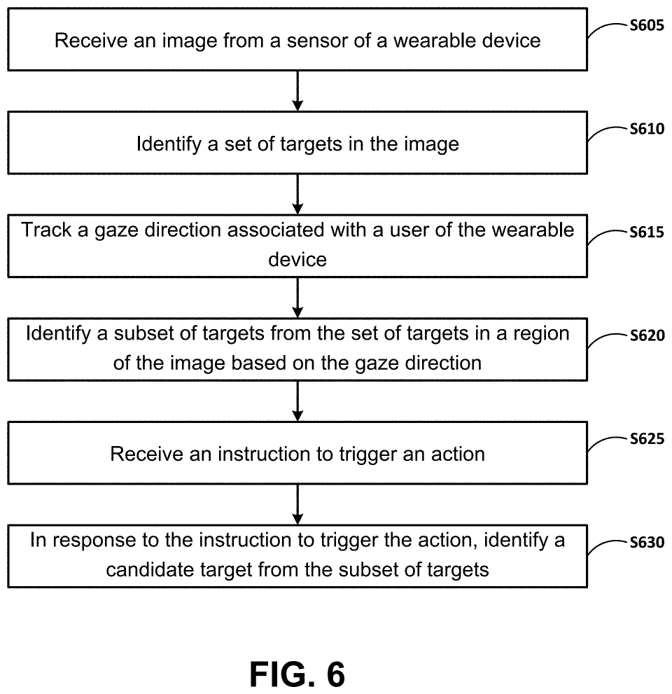

FIG. 6 illustrates a block diagram of a method of target identification according to an example implementation. As shown in FIG. 6, in step S605 an image is received from a sensor of a wearable device. For example, camera 250 can capture an image (or a plurality of images) representing a real-world scene. The image (or one of the plurality of images) can be rendered on screen 305.

In step S610 a set of targets in the image is identified. For example, the image can include a plurality of objects. The objects, or a subset of the objects, can be selected as the set of targets. In step S615 a gaze direction associated with a user of the wearable device is tracked. For example, a gaze line (e.g., gaze line 235) can be drawn on the screen. The gaze line can be used for tracking the gaze of the user.

In step S620 a subset of targets from the set of targets in a region of the image is identified based on the gaze direction. For example, the subset of targets can be identified based on a region encompassing the gaze line.

In step S625 an instruction to trigger an action is received. For example, an action can be triggered (e.g., translate text, find best price, get directions, and/or the like). For example, if the action is to translate text, the text can be associated with a candidate target. The instruction can be a voice command, a gesture, a contact with the wearable device, and/or the like.

In step S630 in response to the instruction to trigger the action, a candidate target from the subset of targets is identified (determined, estimated, and/or the like). For example, in response to the trigger, a candidate target can be estimated (or selected) based on the subset of targets. A depth associated with each target in the set of targets can be estimated. The estimating of the candidate target can be based on an intersection of the gaze line at a depth included in the region. The candidate target can be one of the subset of targets selected based on the intersection of the gaze line at a depth included in the region.

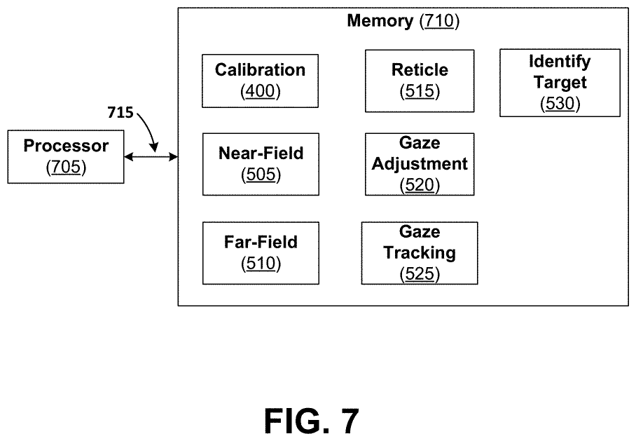

FIG. 7 illustrates a block diagram of a system according to an example implementation. In the example of FIG. 7, a system (e.g., a wearable device) can include, or be associated with, a computing system or at least one computing device (e.g., a mobile computing device, a mobile phone, a laptop computer a tablet, and/or the like) and should be understood to represent virtually any computing device configured to perform the techniques described herein. As such, the system may be understood to include various components which may be utilized to implement the techniques described herein, or different or future versions thereof. By way of example, the system can include a processor 705 and a memory 710 (e.g., a non-transitory computer readable memory). The processor 705 and the memory 710 can be coupled (e.g., communicatively coupled) by a bus 715.

The processor 705 may be utilized to execute instructions stored on the at least one memory 710. Therefore, the processor 705 can implement the various features and functions described herein, or additional or alternative features and functions. The processor 705 and the at least one memory 710 may be utilized for various other purposes. For example, the at least one memory 710 may represent an example of various types of memory and related hardware and software which may be used to implement any one of the modules described herein.

The at least one memory 710 may be configured to store data and/or information associated with the device. The at least one memory 710 may be a shared resource. Therefore, the at least one memory 710 may be configured to store data and/or information associated with other elements (e.g., image/video processing or wired/wireless communication) within the larger system. Together, the processor 705 and the at least one memory 710 may be utilized to implement the techniques described herein. As such, the techniques described herein can be implemented as code segments (e.g., software) stored on the memory 710 and executed by the processor 705. Accordingly, the memory 710 can include the calibration 400 block, the near-field 505 block, the far-field 510 block, the reticle 515 block, the gaze adjustment 520 block, the gaze tracking 525 block, and the identify target 530 block. In one or more example implementations, a subset of the components illustrated as included in the memory 710 can be used. For example, the memory 710 can include the calibration 400 block without the other components.

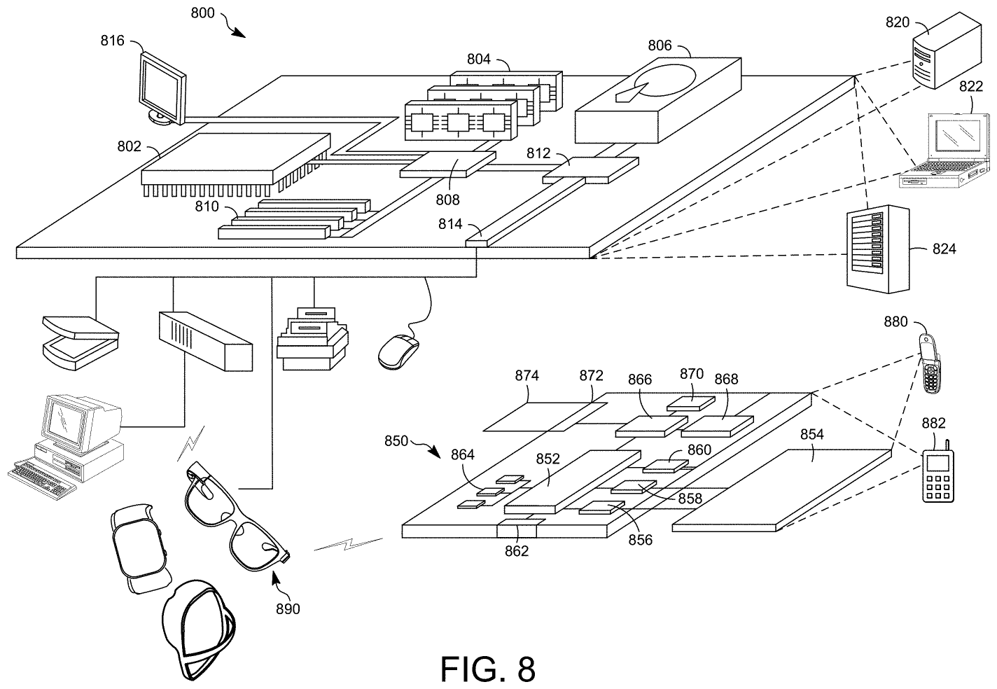

FIG. 8 illustrates an example of a computer device 800 and a mobile computer device 850, which may be used with the techniques described here (e.g., to implement the wearable device). The computing device 800 includes a processor 802, memory 804, a storage device 806, a high-speed interface 808 connecting to memory 804 and high-speed expansion ports 810, and a low-speed interface 812 connecting to low-speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high-speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high-speed controller 808 manages bandwidth-intensive operations for the computing device 800, while the low-speed controller 812 manages lower bandwidth-intensive operations. Such allocation of functions is example only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display), and LED (Light Emitting Diode) or an OLED (Organic Light Emitting Diode) display, or other appropriate display technology. The display interface 856 may include appropriate circuitry for driving the display 854 to present graphical and other information to a user. The control interface 858 may receive commands from a user and convert them for submission to the processor 852. In addition, an external interface 862 may be provided in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In-Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852, that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, Wi-Fi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smartphone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in the figure can include sensors that interface with an AR headset/HMD device 890 to generate an augmented environment for viewing inserted content within the physical space. For example, one or more sensors included on a computing device 850 or other computing device depicted in the figure, can provide input to the AR headset 890 or in general, provide input to an AR space. The sensors can include, but are not limited to, a touchscreen, accelerometers, gyroscopes, pressure sensors, biometric sensors, temperature sensors, humidity sensors, and ambient light sensors. The computing device 850 can use the sensors to determine an absolute position and/or a detected rotation of the computing device in the AR space that can then be used as input to the AR space. For example, the computing device 850 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device 850 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 850 when the computing device is incorporated into the AR space can cause a particular action to occur in the AR space.

In some implementations, a touchscreen of the computing device 850 can be rendered as a touchpad in AR space. A user can interact with the touchscreen of the computing device 850. The interactions are rendered, in AR headset 890 for example, as movements on the rendered touchpad in the AR space. The rendered movements can control virtual objects in the AR space.

In some implementations, one or more output devices included on the computing device 850 can provide output and/or feedback to a user of the AR headset 890 in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 850 may appear as another object in a computer-generated, 3D environment. Interactions by the user with the computing device 850 (e.g., rotating, shaking, touching a touchscreen, swiping a finger across a touch screen) can be interpreted as interactions with the object in the AR space. In the example of the laser pointer in an AR space, the computing device 850 appears as a virtual laser pointer in the computer-generated, 3D environment. As the user manipulates the computing device 850, the user in the AR space sees movement of the laser pointer. The user receives feedback from interactions with the computing device 850 in the AR environment on the computing device 850 or on the AR headset 890. The user's interactions with the computing device may be translated to interactions with a user interface generated in the AR environment for a controllable device.

In some implementations, a computing device 850 may include a touchscreen. For example, a user can interact with the touchscreen to interact with a user interface for a controllable device. For example, the touchscreen may include user interface elements such as sliders that can control properties of the controllable device.

Computing device 800 is intended to represent various forms of digital computers and devices, including, but not limited to laptops, desktops, workstations, personal digital assistants, servers, blade servers, mainframes, and other appropriate computers. Computing device 850 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

1. A method comprising:
receiving an image from a sensor of a wearable device;
rendering the image on a display of the wearable device;
identifying a set of targets in the image;
tracking a gaze direction associated with a user of the wearable device;
rendering, on the displayed image, a gaze line based on the tracked gaze direction;
identifying a subset of targets based on the set of targets in a region of the image based on the gaze line;
triggering an action; and
in response to the trigger, estimating a candidate target based on the subset of targets.

2. The method of claim 1, further comprising:
identifying the subset of targets based on a region encompassing the gaze line; and
estimating a depth associated with each target in the set of targets, wherein the estimating of the candidate target based on an intersection of the gaze line at a depth included in the region.

3. The method of claim 1, further comprising:
detecting a change in gaze direction;
determining that the change is less than a threshold; and
re-rendering the image on a display of the wearable device.

4. The method of claim 1, further comprising:
detecting a change in gaze direction;
determining that the change is less than a threshold; and
re-rendering the gaze line.

5. The method of claim 1, further comprising:
detecting a change in gaze direction;
determining that the change is within the rendered image and closer to the subset of targets; and
re-rendering the gaze line with a change in color.

6. The method of claim 1, further comprising:
detecting a change in gaze direction;
determining that the change is greater than a threshold; and
receiving another image from the sensor.

7. The method of claim 1, further comprising:
rendering a reticle on the displayed image based on a position of the candidate target.

8. The method of claim 7, further comprising:
causing the reticle to relocate to a different position on the displayed image, wherein candidate target is estimated based on the relocated reticle.

9. The method of claim 1, further comprising:
calibrating the wearable device based on a position of the sensor of the wearable device and a center of a display of the wearable device.

10. A wearable device comprising:
an image sensor;
a display;
at least one processor; and
at least one memory including computer program code,
the at least one memory and the computer program code configured to, with the at least one processor, cause the wearable device to:
receive an image from the image sensor;
render the image on the display;
identify a set of targets in the image;
track a gaze direction associated with a user of the wearable device;
render, on the displayed image, a gaze line based on the tracked gaze direction;
identify a subset of targets based on the set of targets in a region of the image based on the gaze line;
trigger an action; and
in response to the trigger, estimate a candidate target based on the subset of targets.

11. The wearable device of claim 10, wherein the computer program code further causes the wearable device to:
identify the subset of targets based on a region encompassing the gaze line; and
estimate a depth associated with each target in the set of targets, wherein the estimating of the candidate target based on an intersection of the gaze line at a depth included in the region.

12. The wearable device of claim 10, wherein the computer program code further causes the wearable device to:
detect a change in gaze direction;
determine that the change is less than a threshold; and
re-render the image on a display of the wearable device.

13. The wearable device of claim 10, wherein the computer program code further causes the wearable device to:
detect a change in gaze direction;
determine that the change is less than a threshold; and
re-render the gaze line.

14. The wearable device of claim 10, wherein the computer program code further causes the wearable device to:
detect a change in gaze direction;
determine that the change is within the rendered image and closer to the subset of targets; and
re-render the gaze line with a change in color.

15. The wearable device of claim 10, wherein the computer program code further causes the wearable device to:
detect a change in gaze direction;
determine that the change is greater than a threshold; and
receiving another image from the sensor.

16. The wearable device of claim 10, wherein the computer program code further causes the wearable device to:
render a reticle on the displayed image based on a position of the candidate target.

17. The wearable device of claim 16, wherein the computer program code further causes the wearable device to:
cause the reticle to relocate to a different position on the displayed image, wherein candidate target is estimated based on the relocated reticle.

18. The wearable device of claim 10, wherein the computer program code further causes the wearable device to:
calibrate the wearable device based on a position of the sensor of the wearable device and a center of a display of the wearable device.

19. A non-transitory computer-readable medium storing executable instructions that when executed by at least one processor cause the at least one processor to:
receive an image from a sensor of a wearable device;
render the image on a display of the wearable device;
identify a set of targets in the image;
track a gaze direction associated with a user of the wearable device;
render, on the displayed image, a gaze line based on the tracked gaze direction;
identify a subset of targets based on the set of targets in a region of the image based on the gaze line;
trigger an action; and
in response to the trigger, estimate a candidate target based on the subset of targets.

20. The non-transitory computer-readable medium of claim 19, wherein the executable instructions further causes the processor to:
identify the subset of targets based on a region encompassing the gaze line; and
estimate a depth associated with each target in the set of targets, wherein the estimating of the candidate target based on an intersection of the gaze line at a depth included in the region.
